(19) United States
(12) Patent Application Publication
(10) Pub. No.: US 2026/0031284 A1
(43) Pub. Date: Jan. 29, 2026

(54) SWITCHING DEVICE

(71) Applicant: NOARK ELECTRICS(SHANGHAI) CO. LTD., Songjiang District, Shanghai (CN)

(72) Inventors: Kejun LU, Songjiang District, Shanghai (CN); Shaojun GUO, Songjiang District, Shanghai (CN); Yanqun YANG, Songjiang District, Shanghai (CN); Zhangqing ZHOU, Songjiang District, Shanghai (CN); Hao FU, Songjiang District, Shanghai (CN); Yuan WANG, Songjiang District, Shanghai (CN)

(21) Appl. No.: 18/992,975

(22) PCT Filed: Mar. 13, 2024
(86) PCT No.: PCT/CN2024/081409

§ 371 Date: Jan. 10, 2025

(30) Foreign Application Priority Data
Mar. 14, 2023 (CN) 202310253659.7
Mar. 14, 2023 (CN) 202310254151.9

(51) Int. Cl. H01H 9/38; H01H 9/32; H01H 9/36; H01H 50/38; H01H 50/54

(52) U.S. Cl. CPC H01H 9/386; H01H 9/32; H01H 9/36; H01H 50/38; H01H 50/541

(57) ABSTRACT

A switching device includes a switch housing and an electromagnetic system including an electromagnetic coil, a static iron core and a moving iron core. The switch housing includes an electromagnetic mounting cavity, in which the electromagnetic system resides, and a contact module mounting cavity, in which a contact module resides. The contact module includes a static contact, a moving contact and an arc-extinguishing chamber in the contact module housing. The moving iron core is connected to the moving contact and drives the moving contact in a straight line. The contact module housing has a first linkage hole through which a linkage member passes to connect the moving iron core with the moving contact. The contact mechanism is encapsulated, and mounted in the switch housing to reduce, the overall height of the switch, and the influence of an arc on the electromagnetic system.

The present application claims priority to the Chinese patent applications CN202310254151.9, filed on Mar. 14, 2023 and entitled “Switching Device” and CN202310253659.7, filed on Mar. 14, 2023 and entitled “Arc-extinguishing Structure”.

### TECHNICAL FIELD

The present invention relates to the field of low-voltage electrical appliances, in particular to a switching device

### BACKGROUND

The existing DC switch suitable for new energy vehicles is not suitable for new energy vehicles with limited mounting spaces owing to high overall mounting height. In addition, a contact mechanism of the DC switch is directly mounted in a switch housing, but the assembly and replacement are more complicated. In addition, because an arc generated by the contact mechanism is easy to have an impact on an electromagnetic system, the higher a rated current, the greater the impact, so that the contact mechanism is difficult to be mounted close to the electromagnetic system, and the requirements of the new energy vehicles for small height and higher rated current can be satisfied.

### SUMMARY

An object of the present invention is to overcome at least one defect of the prior art and provide a switching device.

In order to achieve the above object, the present invention adopts the following technical solutions:
a switching device, comprising a switch housing and an electromagnetic system arranged in the switch housing, wherein the electromagnetic system comprises an electromagnetic coil, a static iron core and a moving iron core; the switch housing comprises an electromagnetic mounting cavity and at least one contact module mounting cavity which are arranged side by side; the electromagnetic system is arranged in the electromagnetic mounting cavity; a contact module is arranged in the contact module mounting cavity; the contact module comprises a contact module housing, and a static contact, a moving contact and an arc-extinguishing chamber arranged in the contact module housing; the moving iron core is connected to the moving contact through a linkage member to drive the moving contact to move in a straight line; the contact module housing is provided with a first linkage hole; and the linkage member passes through the first linkage hole to connect the moving iron core with the moving contact.

Optionally, the switch housing is provided with two contact module mounting cavities inside; the two contact module mounting cavities are respectively located on both sides of the electromagnetic mounting cavity; the two contact modules are arranged in the two contact module mounting cavities; and the moving iron core of the electromagnetic system is connected to the moving contacts of the two contact modules through the linkage member.

Optionally, two static contacts, a moving contact and two arc-extinguishing chambers are arranged in the contact module housing; the moving contact includes a contact mounted on the contact support; the static contact is provided with a first contact portion; a second contact portion is arranged at both ends of the contact, respectively; and the contact support is capable of moving in a straight line to drive the two second contact portions of the contact to be in contact with or separated from the first contact portions of the two static contacts.

Optionally, the two static contacts are arranged on both sides of the contact support; the two arc-extinguishing chambers are symmetrically arranged on both sides of the two static contacts; and the two static contacts are respectively located between the corresponding arc-extinguishing chamber and the contact support.

Optionally, two sets of permanent magnets are also arranged in the switch housing; the two sets of permanent magnets are arranged to correspond to the two static contacts and the two arc-extinguishing chambers, respectively; each set of permanent magnets comprises a first permanent magnet and a second permanent magnet which are arranged at intervals in parallel; and a region between the first permanent magnet and the second permanent magnet is at least provided with the corresponding arc-extinguishing chamber, the first contact portions of the static contacts and the second contact portion of the moving contact.

Optionally, two sets of magnetic conductive plates are further arranged in the switch housing; a set of magnetic conductive plates is arranged on the outer side of each set of permanent magnets; the magnetic conductive plates comprise a first magnetic conductive plate, a second magnetic conductive plate and a connecting plate; the first magnetic conductive plate and the second magnetic conductive plate are arranged in parallel; the connecting plate is connected to the first magnetic conductive plate and the second magnetic conductive plate; and the first magnetic conductive plate and the second magnetic conductive plate are correspondingly arranged on the outer side of the first permanent magnet and the outer side of the second permanent magnet respectively.

Optionally, the first permanent magnet and the second permanent magnet in each set of permanent magnets are opposite in polarity.

Optionally, first outer grooves for mounting the permanent magnets are formed in the outer side of the contact module housing; and the first outer grooves are used for mounting the magnetic guide plates at the same time.

Optionally, the static contact is provided with a first arc-striking portion; the first arc-striking portion is connected to the first contact portion and extends to one side of the corresponding arc-extinguishing chamber in a direction of the corresponding arc-extinguishing chamber; the contact is provided with a third arc-striking portion; and the third arc-striking portion is connected to the second contact portion and extends in the direction of the corresponding arc-extinguishing chamber.

Optionally, the static contact is also provided with a second arc-striking portion; and the second arc-striking portion is connected to the first contact portion and extends in a direction opposite to an extension direction of the first arc-striking portion.

Optionally, the contact comprises a second connecting portion, two second contact portions and two second inclined portions; the two second contact portions are respectively connected to both ends of the second connecting portion through the two second inclined portions; a slope of the second inclined portion is opposite to the second arc-striking portion; and a slope of the second inclined portion and the second arc-striking portion are both inclined in directions away from each other.

Optionally, the two static contacts are located on the same side of the moving contact; an arc isolation plate and an arc isolation plate spring are arranged in the contact module housing; the arc isolation plate is arranged between the two static contacts and is used for separating two breakpoint arcs; the arc isolation plate spring is connected to the arc isolation plate and used for driving the arc isolation plate to move toward the moving contact; and when the moving contact moves to the two static contacts and closes, the arc isolation plate can be pushed to compress the arc isolation plate spring.

Optionally, the static contact is provided with a first avoidance hole; and the second contact portions at both ends of the contact pass through the first avoidance holes of the two static contacts respectively and cooperate with the first contact portions of the corresponding static contacts.

Optionally, the static contact comprises a first contact portion, a first connecting portion and a first wiring portion; the first contact portion, the first connecting portion and the first wiring portion are sequentially connected into a C-type structure; the first contact portion and the first wiring portion are oppositely arranged at intervals; both ends of the first connecting portion are respectively connected to one end of the first contact portion and one end of the first wiring portion; openings of the C-type structures of the two static contacts are arranged away from each other, and are oriented to the corresponding arc-extinguishing chambers; the first connecting portion is provided with a first avoidance hole; and the second contact portions at both ends of the contact pass through the first avoidance holes of the two static contacts respectively and cooperate with the first contact portions corresponding to the static contacts.

Optionally, a first arc guide member is arranged on one side of the contact away from the first contact portion of the static contact; the first arc guide member comprises two arc guide portions and a third connecting portion connected between the two arc guide portions; and the two arc guide portions extend to the other sides of the two arc-extinguishing chambers respectively, so that the arc-extinguishing chamber is arranged between the first arc-striking portion and the arc guide portion.

According to the switching device of the present invention, a contact module housing which is used for encapsulating a contact mechanism is also arranged in a switch housing, and the contact module housing encapsulates a static contact, a moving contact and an arc-extinguishing chamber into a contact module and is then integrally mounted in the switch housing, so that the contact module can be mounted side by side with an electromagnetic system, the overall height of the switch is reduced, and the influence of an arc generated by the contact module on the electromagnetic system is reduced, a higher rated current can be used, and the life of the product is prolonged.

In addition, a magnetic blowing structure of the switching device is provided with two sets of permanent magnets, which are suitable for a structure of two static contacts and two arc-extinguishing chambers, and the two sets of permanent magnets are arranged to correspond to the two static contacts and the two arc-extinguishing chambers respectively. The arc is driven towards the arc-extinguishing chambers by using a magnetic field, thereby accelerating the arc into the arc-extinguishing chambers.

In addition, a first permanent magnet A and a second permanent magnet B in each set of permanent magnets are opposite in polarity, so that when a small current is broken, a breaking arc on one side is driven towards the corresponding arc-extinguishing chamber, and a breaking arc on the other side is driven to an opposite direction of the corresponding arc-extinguishing chamber, thereby achieving a non-polarity application. When a high current is broken, under the excitation of a magnetic field of a conductive loop, the breaking arcs on both sides move to the two arc-extinguishing chambers respectively, which can increase an arc-extinguishing speed.

In addition, an arc running structure of the switching device guides the arcs to the arc-extinguishing chambers, and can elongate the arcs, so that the arc-extinguishing chambers have higher utilization rate and can be used for a switch of higher rated current.

In addition, a first arc guide member is arranged on a side of a contact away from the back of a first contact portion of the static contact, and an arc guide portion of the first arc guide member extends to an upper side of the arc-extinguishing chamber, such that the arc-extinguishing chamber is arranged between a first arc-striking part and the arc guide portion. A third arc-striking portion is also arranged on the contact and can guide the arcs to jump to the first arc guide member faster. In addition, a third connecting portion electrically connects the two arc guide portions, such that the arcs that jump to the first arc-striking portion and the arc guide portion can be fully elongated. Therefore, the arc-extinguishing chamber has higher utilization rate and can be used for a switch of higher rated current.

In addition, a C-type structure of the static contact and a structure of the first avoidance hole allowing the contact to pass through are conducive to improving an arc-striking effect and a driving force of an excitation magnetic field of a moving and static contact conductive loop of the magnetic blowing structure, and increasing an opening distance between the first contact portion and a second contact portion after opening.

### BRIEF DESCRIPTION OF THE DRAWINGS

FIG. 1 is a schematic diagram of a three-dimensional structure of an embodiment of a switching device;

FIG. 2 is a schematic side view of an embodiment of the switching device;

FIG. 3 is a schematic diagram of an overall structure of a contact module in Embodiment 1;

FIG. 4 is a sectional view of the contact module in Embodiment 1;

FIG. 5 is an exploded view of the contact module in Embodiment 1;

FIG. 6 is a schematic diagram of an overall structure of a contact module in Embodiment 2;

FIG. 7 is a sectional view of the contact module in Embodiment 2;

FIG. 8 is an exploded view of the contact module in Embodiment 2;

FIG. 9 is a schematic structural diagram of Embodiment 3 in which a contact unit and an electromagnetic unit are assembled into a switching device;

FIG. 10 is a schematic exploded view of the contact unit and the electromagnetic unit in Embodiment 3;

FIG. 11 is a schematic diagram of an internal structure of the electromagnetic unit in the present embodiment of Embodiment 3;

FIG. 12 is a schematic diagram of an internal structure of the contact unit in Embodiment 3;

FIG. 13 is a schematic diagram of an internal structure of the contact unit in Embodiment 3;

FIG. 14 is a schematic structural diagram of an arc running structure in Embodiment 3;

FIG. 15 is a sectional view of a moving contact and a static contact in Embodiment 3;

FIG. 16 is a schematic structural diagram of the static contact in Embodiment 3;

FIG. 17 is a schematic diagram of a current loop path at the time of opening;

FIG. 18 is a schematic diagram of a current loop path in an initial phase of opening;

FIG. 19 is a schematic diagram of a current loop path in a subsequent stage of opening;

FIG. 20 is a schematic diagram of an assembly structure of the contact unit in Embodiment 3;

FIG. 21 is a sectional view of the contact unit in Embodiment 3;

FIG. 22 is a schematic diagram of a magnetic blowing structure of the contact unit in Embodiment 3;

FIG. 23 is a schematic diagram of an effect of the magnetic blowing structure on an arc in the case of a small breaking current;

FIG. 24 is a schematic diagram of an effect of the magnetic blowing structure on an arc in the case of a large breaking current; and

FIG. 25 is a schematic diagram of an effect of an excitation magnetic field of a moving and static contact conductive loop on an arc.

### REFERENCE SIGNS OF COMPONENTS IN DRAWINGS ARE DESCRIBED AS FOLLOWS

1-contact unit; 10-contact module; 101-first linkage hole; 102-module exhaust port; 103-power supply wiring portion; 104-isolation protrusion; 11-static contact; 11A-first static contact; 11B-second static contact; 111-first contact portion; 1114-first arc-shaped surface; 1115-second arc-shaped surface; 112-first connecting portion; 113-first wiring portion; 114-first arc-striking portion; 1141-first inclined section; 1142-first straight section; 115-second arc-striking portion; 116-first avoidance hole; 12-moving contact; 120-contact; 121-second contact portion; 122-third arc-striking portion; 123-second connecting portion; 124-contact support; 1241-contact mounting groove; 1242-spring mounting groove; 1243-baffle plate; 1245-connecting hole; 125-second inclined portion; 126-contact spring; 13-first arc guide member; 131-first arc guide portion; 132-third connecting portion; 133-second arc guide portion; 1301-second straight section; 1302-second inclined section; 1303-third straight section; 14-arc-extinguishing chamber; 15-arc isolation plate spring; 16-arc isolation plate; 17-magnetic conductive plate; 171-first magnetic conductive plate; 173-second magnetic conductive plate; 172-connecting plate; 18-permanent magnet; 18A-first permanent magnet; 18B-second permanent magnet; 181-first permanent magnet plate; 182-second permanent magnet plate; 183-third permanent magnet plate; 2-electromagnetic unit; 20-electromagnetic unit housing; 201-second linkage hole; 21-electromagnetic coil; 22-moving iron core; 23-static iron core; 24-reset spring; 25-linkage member; 30-contact module housing; 30A-first module housing; 30B-second module housing; 31-limiting boss; 32-sliding groove; 33-spring groove; 34-static contact mounting groove; 35-first outer groove; 40-switch housing; 40A-first housing; 40B-second housing; 401-wiring hole; 402-exhaust hole; 403-control wiring groove; H-contact unit housing; H1-first base; H2-second base.

### DETAILED DESCRIPTION OF THE INVENTION

The specific implementation of a switching device of the present invention will be further described below with reference to the embodiments given in accompanying drawings. The switching device of the present invention is not limited to the description of the following embodiments.

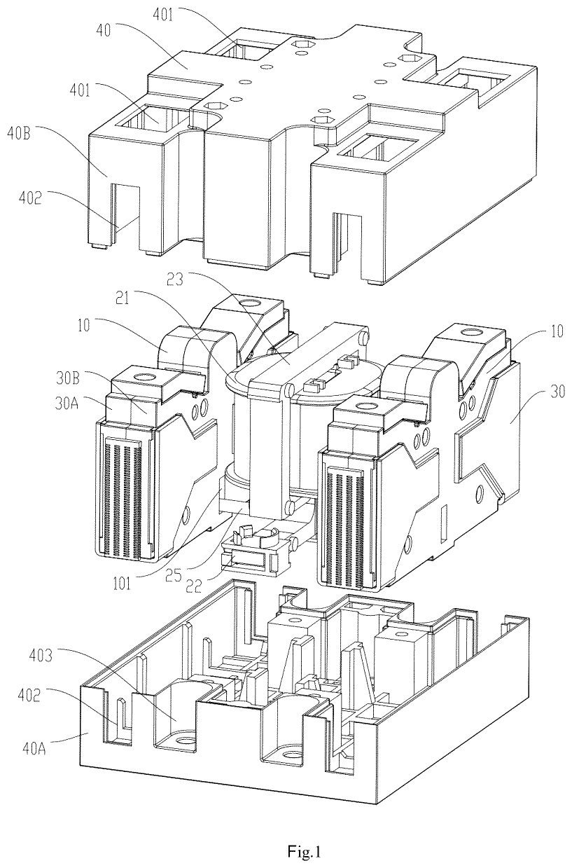

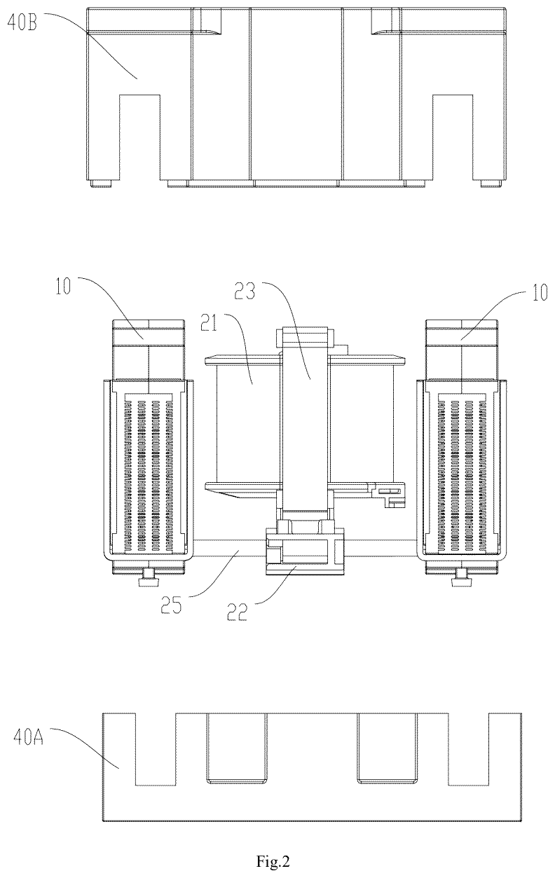

Referring to FIGS. 1-4, the switching device includes a contact mechanism and an electromagnetic mechanism. The electromagnetic mechanism includes an electromagnetic coil 21, a static iron core 23, a moving iron core 22 and a reset spring 24. The electromagnetic coil 21 is used for generating an electromagnetic force to drive the moving iron core 22 to move towards the static iron core 23. The reset spring 24 acts on the moving iron core 22. When the electromagnetic coil 21 works for electric conduction, an electromagnetic force is generated to drive the moving iron core 22 to move towards the static iron core 23 and make an attraction, and the moving iron core 22 allows the reset spring 24 to store energy. When the electromagnetic coil 21 stops working, the reset spring 24 pushes the moving iron core 22 to move in a direction away from the static iron core 23 and make a repulsion in the process of restoring deformation. The contact mechanism includes a static contact 11 and a moving contact 12. The moving iron core 22 of the electromagnetic mechanism can drive the moving contact 12 to move, such that the moving contact is in contact with and separated from the static contact 11 for achieving closing and opening operations of the switching device, all of which are the prior art.

As shown in FIGS. 1-4, an embodiment of a switching device of the present invention is shown. The switching device in the present embodiment is a DC switch. The switching device includes a switch housing 40, and an electromagnetic system and a contact module 10 arranged in the switch housing 40. The electromagnetic system and the contact module 10 are arranged side by side in a width direction of the switching device. The electromagnetic system includes an electromagnetic coil 21, a static iron core 23 and a moving iron core 22. The switch housing 40 includes an electromagnetic mounting cavity and at least one contact module mounting cavity arranged side by side. The electromagnetic system is arranged in the electromagnetic mounting cavity. The contact module 10 is arranged in the contact module mounting cavity. The contact module 10 includes a contact module housing 30, and a static contact 11, a moving contact 12 and an arc-extinguishing chamber 14 arranged in the contact module housing 30. The moving iron core 22 is connected to the moving contact 12 through a linkage member 25 to drive the moving contact 12 to move in a straight line. The contact module housing 30 is provided with a first linkage hole 101, and the linkage member 25 passes through the first linkage hole 101 and connects the moving iron core 22 with the moving contact 12.

According to the switching device in the present embodiment, the contact module housing 30 which is used for encapsulating a contact mechanism is also arranged in the switch housing 40, and the contact module housing 30 encapsulates a static contact 11, a moving contact 12 and an arc-extinguishing chamber 14 into a contact module and is then integrally mounted in the switch housing 40, so that the contact module can be mounted side by side with the electromagnetic system, the overall height of the switch is reduced, the influence of an arc generated by the contact module on the electromagnetic system is reduced, a higher rated current can be used, and the life of the product is prolonged.

As shown in FIG. 1, the switching device in the present embodiment includes two contact modules 10. The switch housing 40 is provided with two contact module mounting cavities. The two contact module mounting cavities are respectively located in the left side and the right side of the electromagnetic mounting cavity. The two contact modules 10 are arranged in the two contact module mounting cavities. The moving iron core 22 of the electromagnetic system is connected to the moving contacts 12 of the two contact modules 10 through the linkage member 25, so as to balance a driving force of the moving iron core 22. It should be noted that the two contact modules 10 may also be arranged on the same side of the electromagnetic system. The moving contacts 12 of the adjacent contact modules 10 are connected through the linkage member 25. In addition, the switching device may only be provided with one contact module 10 as required, or also with three or more contact modules 10.

As shown in FIG. 1, the switch housing 40 in the present embodiment includes a first housing 40A and a second housing 40B. The first housing 40A and the second housing 40B are oppositely mounted in a height direction of the switching device to form the switch housing 40. The first housing 40A and the second housing 40B are each sequentially provided with a contact module mounting cavity, an electromagnetic mounting cavity and a contact module mounting cavity in a width direction. An isolation plate, isolation rib and/or other isolation structures may be arranged between the contact module mounting cavity and the electromagnetic mounting cavity. A corresponding positioning block for fixing the static iron core 23 and/or the electromagnetic coil 21 and a guide mechanism for providing guidance for a straight-line movement of the moving iron core 22 are arranged in the electromagnetic mounting cavity.

As shown in FIG. 1, the contact module housing 30 includes a first module housing 30A and a second module housing 30B. The first module housing 30A and the second module housing 30B are oppositely mounted in a width direction of the switching device to form the contact module housing 30. The two static contacts 11, the moving contact 12 and the two arc-extinguishing chambers 14 are mounted between the first module housing 30A and the second module housing 30B. A first mounting space in which the contact mechanism is arranged is formed between the first module housing 30A and the second module housing 30B, which can be connected to form an integral contact module by means of screws, rivets, buckles or the like, and then integrally mounted between the first housing 40A and the second housing 40B. A side wall of the contact module housing 30 in a width direction is provided with a first linkage hole 101 for the linkage member 25 to pass through. A side wall of the contact module housing 30 in a length direction is provided with a module exhaust port 102. The module exhaust port 102 corresponds to an exhaust end of the arc-extinguishing chamber 14 of the contact module 10 and used for exhausting an arcing gas.

A wiring hole 401 is formed in the switch housing 40, and used for the power supply wiring portion 103 to extend out to connect a power supply and a load. Preferably, the wiring hole 401 and the power supply wiring portion 103 are arranged on a top side of the switch housing 40, that is, a top side of the first housing 40A, so as to facilitate wiring. Preferably, the top side of the switch housing 40 is provided with a cross-shaped protrusion structure. Four wiring grooves are formed in four end pins on the top side of the switch housing 40, and a wiring hole 401 for the power supply wiring portion 103 to extend out is formed in each wiring groove. The cross-shaped protrusion structure plays the role of increasing a creepage distance. Preferably, the side wall of the switch housing 40 is further provided with an exhaust hole 402 and a control wiring groove 403. The exhaust hole 402 corresponds to the module exhaust port 102 and is used for discharging an arcing gas. The control wiring groove 403 is used for mounting and connecting the control wiring portion of the electromagnetic system. The control wiring portion is used for supplying power to the electromagnetic coil 21 and driving the moving iron core 22 to act.

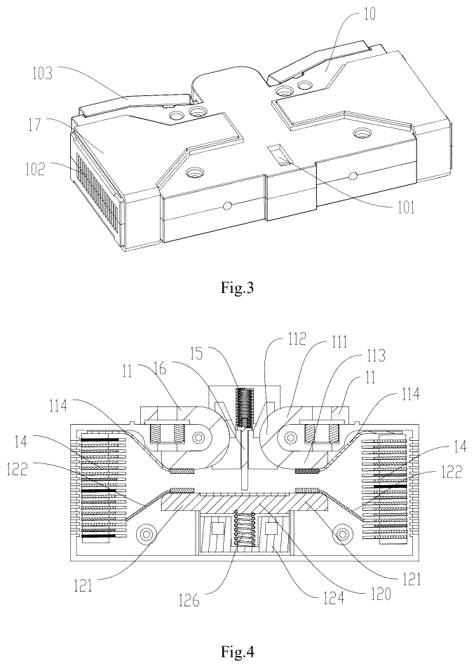

As shown in FIGS. 3-5, Embodiment 1 of the contact module 10 is shown. The contact module 10 in the present embodiment includes a moving contact 12, two static contacts 11 and two arc-extinguishing chambers 14. Each static contact 11 is provided with a first contact portion 111. The moving contact 12 includes a contact 120 mounted on the contact support 124. A second contact portion 121 is respectively arranged at both ends of the contact 120. The two second contact portions 121 are used for matching with the two static contacts 11. The moving iron core 22 of the electromagnetic system can drive the contact support 124 to move in a straight line, so that the two second contact portions 121 of the contact 120 are in contact with and separated from the first contact portions 111 of the two static contacts 1 for implementing closing and opening operations of the switching device. The arc-extinguishing chambers 14 are used for extinguishing an arc generated when the moving contact 12 and the static contacts 11 are opened. The moving contact 12 includes a contact 120, a contact support 124 and a contact spring 126. The contact support 124 can move in a straight line in the contact module housing 30 in a height direction of the switching device. The contact 120 is mounted on the contact support 124. The contact spring 126 is arranged between the contact 120 and the contact support 124, and is used for fixing the contact 120 on the contact support 124, thereby realizing over-travel and ensuring that the second contact portion 121 is in reliable contact with the static contact 11. The two static contacts 11 are symmetrically arranged on both sides of the contact support 124. The two arc-extinguishing chambers 14 are arranged on both sides of the moving contact 12, that is, symmetrically arranged on both sides of the contact 120 and the contact support 124. The two arc-extinguishing chambers 14 are respectively arranged on both sides away from contact regions between the moving contact 12 and the two static contacts 11 and are arranged symmetrically. Preferably, the two arc-extinguishing chambers 14 are symmetrically arranged on both sides of the two static contacts 11. The two static contacts 11 are respectively located between the corresponding arc-extinguishing chamber 14 and the contact support 124.

Preferably, as shown in FIGS. 4-5, the static contact 11 includes a first contact portion 111, a first connecting portion 112 and a first wiring portion 113. The first contact portion 111 is used for cooperating with the second contact portion 121 of the contact 120. The first wiring portion 113 is used for connecting a power supply. The first connecting portion 112 is connected between the first contact portion 111 and the first wiring portion 113. In the present embodiment, the first contact portion 111, the first connecting portion 112 and the first wiring portion 113 are sequentially connected into a C-type structure. Both ends of the first connecting portion 112 are connected to one end of the first contact portion 111 and one end of the first wiring portion 113 respectively. The first contact portion 111 is provided with a static contact point. The first wiring portion 113 is provided with a first wiring hole. Openings of the C-type structures of the two static contacts 11 are away from each other, and the openings are oriented to the corresponding arc-extinguishing chambers 14.

Preferably, the static contact 11 is integrally formed by bending a conductive plate. The first wiring portion 113 extends out of the contact module housing 30 and extends out of the switch housing 40 as the power supply wiring portion 103 of the switching device, and is used for connecting a voltage and a load. In addition, the power supply wiring portion 103 may also be connected with a wiring terminal. The wiring terminal is used for electrically connecting the contact module with an external circuit. The wiring terminal can be arranged in various styles.

Preferably, the static contact 11 is provided with a first arc-striking portion 114. The first arc-striking portion 114 is connected to the first contact portion 111 and extends to one side of the corresponding arc-extinguishing chamber 14 in a direction of the corresponding arc-extinguishing chamber 14. The contact 120 is provided with a third arc-striking portion 122. The third arc-striking portion 122 is connected to the second contact portion 121 and extends in a direction of the corresponding arc-extinguishing chamber 14, so that the arc can be guided to move into the arc-extinguishing chamber 14 more quickly, thereby improving the arc-extinguishing efficiency.

In the present embodiment, the two static contacts 11 are located on the same side of the moving contact 12. An arc isolation plate 16 and an arc isolation plate spring 15 are arranged in the contact module housing 30. The arc isolation plate 16 is arranged between the two static contacts 11 and is used for separating two breakpoint arcs. The arc isolation plate spring 15 is connected to the arc isolation plate 16 and is used for driving the arc isolation plate 16 to move to the moving contact 12. When the moving contact 12 moves to the two static contacts 11 and is closed, the arc isolation plate 16 can be pushed to compress the arc isolation plate spring 15. By arranging the movable arc isolation plate 16 between the two static contacts 11, and the arc isolation plate 6 is driven to move through the cooperation between the arc isolation plate spring 15 and the moving contact 12, the arcs on both sides are isolated by the arc isolation plate 6, thereby reducing ablation and other damages of the moving contact 3 and the static contacts 2 caused by the arcs.

Preferably, a limiting boss 31 is arranged in the middle of the contact module housing 30. The limiting boss 31 is located between the two static contacts 11. The limiting boss 31 is provided with a sliding groove 32 and a spring groove 33. The arc isolation plate 16 is mounted in the sliding groove 32 in a straight-line sliding manner. The arc isolation plate spring 15 is mounted in the spring groove 33. The spring groove 33 is communicated with the sliding groove 32. The arc isolation plate 16 extends into the spring groove 33 and is connected to the arc isolation plate spring 15. Static contact mounting grooves 34 for limiting the two static contacts 11 are formed in both sides of the limiting boss 31. The contact support 124 is arranged to correspond to the limiting boss 31. The contact support 124 is provided with a connecting hole 1245 connected to the linkage member 25. The contact support 124 can be driven by the linkage member 25 to move in a direction close to the limiting boss 31 and away from the limiting boss 31, so as to implement the opening and closing operations, and to drive the arc isolation plate 16 to compress the arc isolation plate spring 15 while moving close to the limiting boss 31. The arc isolation plate spring 15 releases energy and drives the arc isolation plate 16 to move in a direction close to the contact support 124 while moving away from the limiting boss 31.

As shown in FIGS. 3 and 5, preferably, two sets of permanent magnets 18 and two sets of magnetic conductive plates 17 are also arranged in the switch housing 40. The two sets of permanent magnets 18 are arranged to correspond to the two static contacts 11 and the two arc-extinguishing chambers 14 respectively. A set of magnetic conductive plates 17 are arranged on the outer side of each set of permanent magnets 18. The arc is driven in a direction of the arc-extinguishing chamber 14 by utilizing a magnetic field, and is accelerated to enter the arc-extinguishing chamber 14. Preferably, the permanent magnets 18 and the magnetic conductive plates 17 are arranged between the contact module housing 30 and the switch housing 40. The permanent magnets 18 are arranged on the outer sides of the first module housing 30A and the second module housing 30B. The magnetic conductive plate 17 is arranged on the outer side of the permanent magnet 18. First outer grooves 35 for mounting the permanent magnets 18 are formed in the outer side of the contact module housing 30. Further, the first outer grooves 35 are used for mounting the magnetic conductive plates 17 at the same time. The first magnetic conductive plates 171 and the second magnetic conductive plates 173 are matched in shape with the first permanent magnet 18A and the second permanent magnet 18B, and are both mounted in the first outer grooves 35.

Preferably, each set of permanent magnets 18 includes a first permanent magnet 18A and a second permanent magnet 18B arranged at intervals in parallel. A region between the first permanent magnet 18A and the second permanent magnet 18B is at least provided with a corresponding arc-extinguishing chamber 14, a first contact portion 111 of the static contact 11 and a second contact portion 121 of the moving contact 12. The magnetic conductive plate 17 includes a first magnetic conductive plate 171, a second magnetic conductive plate 173 and a connecting plate 172. The first magnetic conductive plate 171 and the second conductive plate 173 are arranged in parallel. The connecting plate 172 is connected to the first magnetic conductive plate 171 and the second magnetic conductive plate 173, so that the magnetic conductive plate 17 is U-shaped. The first magnetic conductive plate 171 and the second magnetic conductive plate 173 are correspondingly arranged on the outer sides of the first permanent magnet 18A and the second permanent magnet 18B, respectively. The connecting plate 172 is correspondingly arranged on the lower side of the arc-extinguishing chamber 14 thereby avoiding the exhaust end of the arc-extinguishing chamber 14.

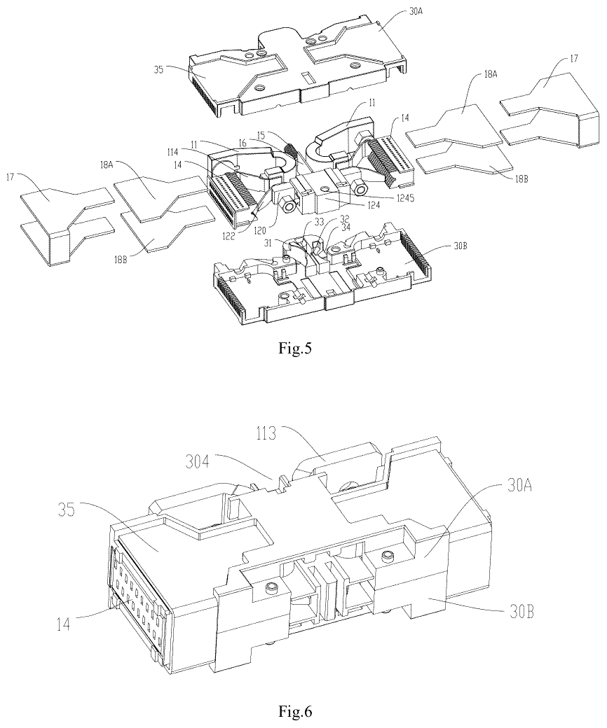

As shown in FIGS. 6-8, Embodiment 2 of the contact module 10 is shown. The contact module 10 in the present embodiment includes a contact module housing 30, and a moving contact 12, two static contacts 11 and two arc-extinguishing chambers 14 arranged in the contact module housing 30. A difference between the present embodiment and the contact module 10 in Embodiment 1 lies in the structure of the static contacts 11. Each static contact 11 of the contact module 10 in the present embodiment is provided with a first avoidance hole. Second contact portions 121 at both ends of the contact 120 pass through the first avoidance holes of the two static contacts 11 respectively and cooperate with the first contact portions 111 of the corresponding static contacts 11.

Specifically, each static contact 11 includes a first contact portion 111, a first connecting portion 112 and a first wiring portion 113. The first contact portion 111, the first connecting portion 112 and the first wiring portion 113 are sequentially connected into a C-type structure. The first contact portion 111 and the first wiring portion 113 are oppositely arranged at intervals. Both ends of the first connecting portion 112 are connected to one end of the first contact portion 111 and one end of the first wiring portion 113, respectively. Openings of the C-type structures of the two static contacts 11 are arranged away from each other. The openings are oriented to the respective arc-extinguishing chambers 14. The first connecting portion 112 is provided with a first avoidance hole. The second contact portions 121 at both ends of the contact 120 pass through the first avoidance holes of the two static contacts 11 respectively and cooperate with the first contact portions 111 of the corresponding static contacts 11. The second contact portion 121 of the contact 120 passes through the first avoidance hole and is arranged between the first wiring portion 113 and the first contact portion 111. The C-type structure of the static contact 11 and the structure of the first avoidance hole allowing the contact 120 to pass through are conducive to improving an arc-striking effect, and an opening distance between the first contact portion 111 and the second contact portion 121 after opening is increased.

Preferably, a baffle plate 1243 is arranged on the contact support 124 in the present embodiment. In the straight-line movement process of the contact support 124, regardless of being closed or opened, the baffle plate 1243 is always located between the first contact portions 111 of the two static contacts 11, so as to isolate the arcs on both sides, and reduce the ablation and other damage of the moving contact 3 and the static contacts 2 caused by the arcs. The baffle plate 1243 and the contact support 124 are integrally formed.

Preferably, a first inner housing hole 304 is respectively formed in two side walls of the contact module housing 30 in the present embodiment perpendicular to a moving direction of the contact support 124. The contact support 124 can extend out of the first inner housing hole 304 to increase its moving stroke, so as to expand an opening distance between the moving contact and the static contact. Preferably, the linkage member 25 for driving the contact support 124 to move can be connected to the contact support 124 extending out of the first inner housing hole 304. That is, the first inner housing hole 304 also plays the role of the first linkage hole 101. Of course, as other embodiments, the first linkage hole 101 may also be formed in a side wall of the contact module housing 30 in a direction parallel to the moving direction of the contact support 124.

The contact module 10 in the present embodiment is also provided with a permanent magnet 18 and a magnetic conductive plate 17, and corresponding structures of a first arc-striking portion 114 and a third arc-striking portion 122, which will not be repeated here.

As shown in FIGS. 9-25, the contact unit and the electromagnetic unit in the present invention are assembled into an embodiment of the switching device. The switching device in the present embodiment is a DC switch. An improvement point of the switching device in the present embodiment lies in a modular design. The switching device includes an electromagnetic unit 2 and at least one contact unit 1 which are arranged side by side. The electromagnetic unit 2 includes an electromagnetic unit housing 20, and an electromagnetic coil 21, a static iron core 23, a moving iron core 22 and a reset spring 24 arranged in the electromagnetic unit housing 20. The contact unit 1 includes a contact unit housing H, and a static contact 11, a moving contact 12 and an arc-extinguishing chamber 14 arranged in the contact unit housing H. The arc-extinguishing chamber 14 is used for extinguishing an arc generated by the breaking of the static contact 11 from the moving contact 12. A first linkage hole 101 is formed in a side wall of the contact unit housing H. A second linkage hole 201 is formed in a side wall of the electromagnetic unit housing 20 which is closely attached to the contact unit housing H. A linkage rod 25 passes through the first linkage hole 101 and the second linkage hole 201 and connects the moving iron core 22 with the moving contact 12.

The switching device in the present embodiment adopts a modular design, which is divided into a contact unit 1 and an electromagnetic unit 2 which are independent of each other. The moving iron core 22 of the electromagnetic unit 2 is in linkage with the moving contact 12 of the contact unit 1 through the linkage rod 25, the electromagnetic coil is driven and easy to control. The contact units 1 of different poles and specifications are assembled according to the user's demands into switching devices of various specifications together with the electromagnetic unit 2, thereby achieving high adaptability and convenience in assembly, maintenance and replacement. Moreover, preferably, the contact unit 1 and the electromagnetic unit 2 are arranged side by side in a width direction, and are stacked in a height direction, such that a size of the switching device in the height direction can be greatly reduced, which is especially conducive to being used in products with a limited space such as automobiles.

The switching device in the present embodiment includes an electromagnetic unit 2 and two contact units 1. The two contact units 1 are respectively arranged on the left and right sides of the electromagnetic unit 2 in the width direction, which is conducive to balancing a driving force of the electromagnetic unit 2. The linkage rod 25 connects the moving iron core 22 with the contact supports of the two contact units 1. It should be noted that the two contact units 1 may be arranged on the same side of the electromagnetic unit 2, and the moving contacts 12 of the adjacent contact units 1 are connected through the linkage rod 25. In addition, the switching device may be provided with only one contact unit 1 as required, or with three or more contact units. In addition, the linkage rod 25 may be directly or indirectly connected to the moving iron core 22 and the moving contact 12. The linkage rod 25 may be an independent element, or may also be arranged as a part of the moving iron core 22 or the moving contact 12.

As shown in FIG. 11, the electromagnetic unit 2 in the present embodiment includes an electromagnetic unit housing 20, and an electromagnetic coil 21, a static iron core 23, a moving iron core 22 and a reset spring 24 arranged in the electromagnetic unit housing 20. The static iron core 23 is fixedly arranged in the electromagnetic unit housing 20. The moving iron core 22, the electromagnetic coil 21 and the static iron core 23 are arranged sequentially, and may be mounted on the static iron core 23. The moving iron core 22 is opposite to the static iron core 23 and is able to move in a straight line in the electromagnetic unit housing 20 in a direction close to the static iron core 23 and away from the static iron core 23. The reset spring 24 is arranged between the moving iron core 22 and the static iron core 23. The linkage rod 25 is arranged on the moving iron core 22. A side wall of the electromagnetic unit housing 20 is provided with a second linkage hole 201, and is in extending transmission with the linkage rod 25 connected to the moving iron core 22, so as to drive the moving contact 12 to move. It should be noted that the static iron core 23 and the moving iron core 22 may be set to U-shaped, E-type or other structures according to needs. The reset spring 24 may be a compression spring, a torsion spring, a leaf spring, etc. One or two or more electromagnetic coils 21 may be provided, all of which belong to the protection scope of the present invention. The electromagnetic unit 2 adopts a modular design and is convenient to assemble. In addition, configurations of different specification can be replaced according to different application scenarios, as long as an interface that matches with the linkage rod 25 is unified.

As shown in FIG. 12, the contact unit 1 in the present embodiment includes a static contact 11, a moving contact 12 and an arc-extinguishing chamber 14 arranged in the contact unit housing H. The contact mechanism in the present embodiment is a bridge-type double-breakpoint contact, and includes a moving contact 12 and two static contacts 11. The two static contacts 11 are a first static contact 11A and a second static contact 11B, respectively. The moving contact 12 includes a contact 120. A second contact portion 121 is respectively arranged on both ends of the contact 120. The two second contact portions 121 are used for cooperating with the two static contacts 11. The moving contact 12 includes a contact 120, a contact support 124 and a contact spring 126. The contact support 124 can move in a straight line in the contact unit housing H. The contact 120 is arranged on the contact support 124. The contact spring 126 is arranged between the contact 120 and the contact support 124, and is used for fixing the contact 120 on the contact support 124, thereby achieving over-travel, and ensuring that the second contact portion 121 is in reliable contact with the static contact 11. The two static contacts 11 are symmetrically arranged on both sides of the contact support 124. The two arc-extinguishing chambers 14 are arranged on both sides of the moving contact 12, that is, symmetrically arranged on both sides of the contact 120 and the contact support 124. The two arc-extinguishing chambers 14 are respectively arranged on both sides away from the contact regions between the moving contact 12 and the two static contacts 11 and are arranged symmetrically. The contact support 124 is provided with a connecting hole 1245 for connection with the linkage rod 25. The first linkage hole 101 corresponds to the contact support 124. The first linkage hole 101 is used for the linkage rod 25 connected to the contact support 124 to pass through, so as to drive the contact support 124 to move in a straight line. The contact unit can be used for assembly with the electromagnetic unit 2 to form the switching device. Two static contacts 11, a moving contact 12 and two arc-extinguishing chambers 14 are arranged in the contact unit. A first linkage hole 101 is formed in a side wall of the contact unit housing H, allows the linkage rod 25 to pass through and is connected to the contact support 124 of the moving contact 12. The contact unit in the present embodiment has high adaptability and is convenient for assembly and replacement. Configurations of different specifications can be replaced according to different application scenarios, as long as interfaces of the first linkage hole 101 and the connecting hole 1245 matched with the linkage rod 25 are unified.

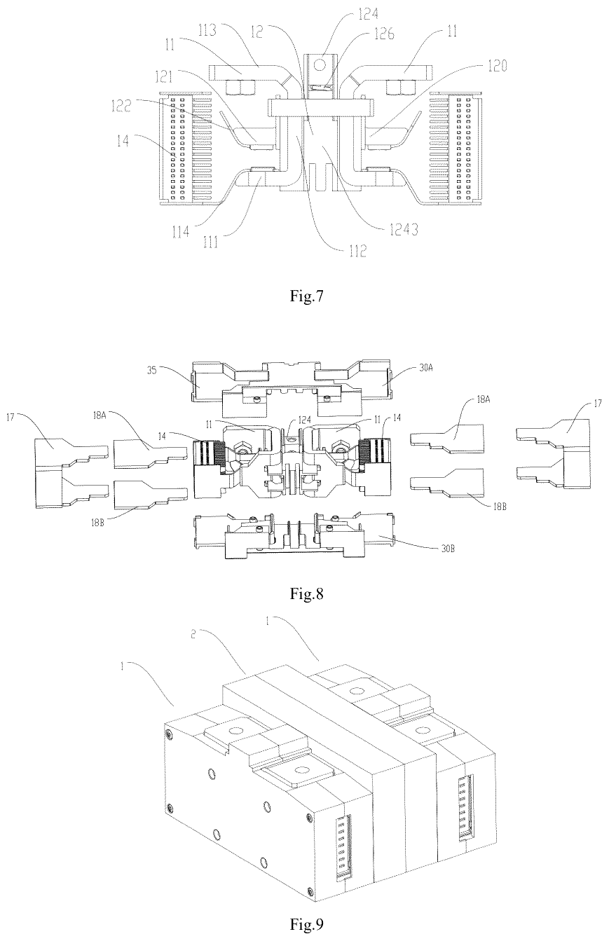

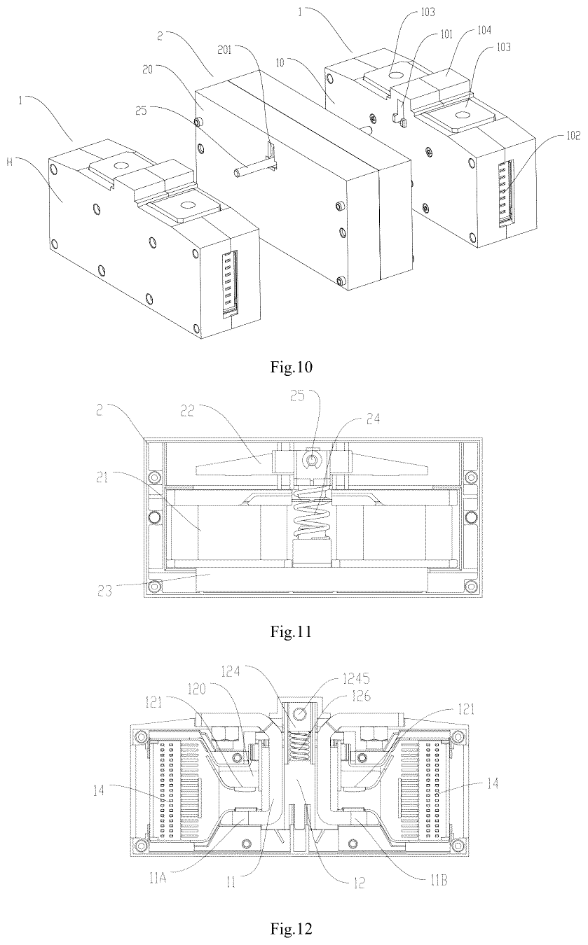

As shown in FIG. 10, the first linkage hole 101 and the second linkage hole 201 are both strip-shaped. The linkage rod 25 can move in a straight line in the first linkage hole 101 and the second linkage hole 201. The length directions of the first linkage hole 101 and the second linkage hole 201 are parallel to a moving direction of the contact support 124.

When the electromagnetic coil 21 works for electric conduction, an electromagnetic force is generated to drive the moving iron core 22 to move towards the static iron core 23 and makes an attraction, the moving iron core 22 drives the contact support 124 to move in a straight line through the linkage rod 25, and the contact support 124 drives the contact 120 to move so that the second contact portions 121 at both ends are in contact with the first static contact 11A and the second static contact 11B respectively, thereby implementing a closing operation (or they may also be separated to implement an opening operation). When the electromagnetic coil 21 stops working, the reset spring 24 pushes the moving iron core 22 to move in a direction away from the static iron core 23 and makes a repulsion, the moving iron core 22 drives the contact support 124 to move in a straight line through the linkage rod 25, and the contact support 124 drives the contact 120 to move so that the second contact portions 121 at both ends are separated from the first static contact 11A and the second static contact 11B respectively, thereby implementing an opening operation (or, they may also be in contact with each other, thereby implementing a closing operation).

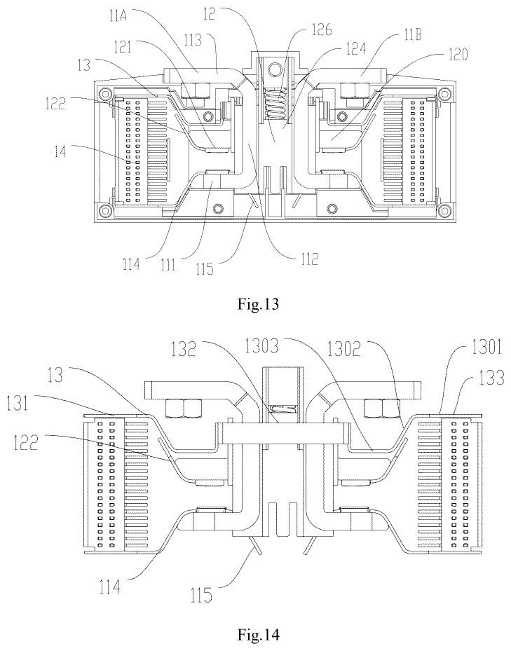

Preferably, as shown in FIGS. 12-13, a preferred embodiment ofa contact unit 1 is shown. The contact support 124 is arranged in the middle of the contact unit 1. The two arc-extinguishing chambers 14 are symmetrically arranged on both sides of the contact support 124. The two static contacts 11 are respectively located between the corresponding arc-extinguishing chamber 14 and the contact support 124. The static contact 11 is arranged between the corresponding arc-extinguishing chamber 14 and the contact support 124, so that the overall structure is more compact, which is conducive to guiding arcs to the arc-extinguishing chamber 14 and the power supply wiring portion 103 of the contact unit 1. Of course, as other embodiments, the static contact 11 may also be arranged on the upper or lower side of the arc-extinguishing chamber 14.

Preferably, as shown in FIGS. 13-14, the arc-extinguishing structure in the contact unit 1 in the present embodiment includes an arc running structure. The arc running structure is used for introducing an arc generated during opening into two arc-extinguishing chambers 14. The arc running structure is located between the contact region of the static contact 11 and the moving contact 12 and the arc-extinguishing chamber 14. A further detailed description is made below in combination with the static contact 11 and the moving contact 12.

As shown in FIGS. 13-14, the static contact 11 includes a first contact portion 111, a first connecting portion 112 and a first wiring portion 113. The first contact portion 111 is used for cooperating with the second contact portion 121 of the contact 120. The first wiring portion 113 is used for connecting a power supply. The first connecting portion 112 is connected between the first contact portion 111 and the first wiring portion 113. Preferably, the static contact 11 is provided with a first avoidance hole 116 for the contact 120 to pass through. The second contact portion 121 of the contact 120 passes through the first avoidance hole 116 and cooperates with the first contact portion 111.

In the present embodiment, the first contact portion 111, the first connecting portion 112 and the first wiring portion 113 are sequentially connected into a C-type structure. The first contact portion 111 and the first wiring portion 113 are oppositely arranged at intervals, and are basically parallel to each other. Both ends of the first connecting portion 112 are connected to one end of the first contact portion 111 and one end of the first wiring portion 113, respectively. The first contact portion 111 is provided with a static contact point. The first wiring portion 113 is provided with a first wiring hole. The first connecting portion 112 is provided with a first avoidance hole 116. The second contact portions 121 at both ends of the contact 120 pass through the first avoidance holes 116 of the two static contacts 11 respectively and cooperate with the first contact portions 111 of the corresponding static contacts 11. The openings of the C-type structures of the two static contacts 11 are arranged away from each other. The openings are oriented to the respective arc-extinguishing chambers 14. The two first connecting portions 112 are arranged at intervals in parallel. The two first wiring portions 113 extend in opposite directions. The two first contact portions 111 extend in opposite directions. The second contact portion 121 of the contact 120 passes through the first avoidance hole 116 and is arranged between the first wiring portion 113 and the first contact portion 111. The contact support 124 drives the contact 120 to move in a straight line. The first avoidance hole 116 avoids the movement of the contact 120. Preferably, the static contact 11 is integrally formed by bending a conductive plate. The first wiring portion 113 extends out of the contact unit 1 as a power supply wiring portion 103 of the contact unit 1 and is used for connecting a voltage and a load. In addition, a wiring terminal may also be connected to the power supply wiring portion 103. The wiring terminal is used for electrically connecting the contact unit with an external circuit. The wiring terminal may also be arranged in various styles.

Preferably, the static contact 11 further includes a first arc-striking portion 114 and a second arc-striking portion 115. The first arc-striking portion 114 and the second arc-striking portion 115 are connected to the first contact portion 111 and extend in opposite directions respectively. The first arc-striking portion 114 extends away from the first connecting portion 112, that is, extends in a direction of the corresponding arc-extinguishing chamber 14 and extends to a lower side of the corresponding arc-extinguishing chamber 14. The second arc-striking portion 115 extends in a direction opposite to an extension direction of the first arc-striking portion 114, that is, extends to a direction where the first connecting portion 112 is located, and passes through the first avoidance hole 116.

Preferably, the contact 120 is provided with third arc-striking portions 122. The two third arc-striking portions 122 are respectively connected to two second contact portions 121 and extend in a direction of the corresponding arc-extinguishing chamber 14. The contact 120 includes a second connecting portion 123 and two second contact portions 121 which are respectively connected to both ends of the second connecting portion 123. The second contact portion 121 is provided with a moving contact point. The contact 120 is mounted on the contact support 124 through the second connecting portion 123. The two third arc-striking portions 122 are respectively connected to the two second contact portions 121 and extend in directions away from each other.

Preferably, there is a drop between the second connecting portion 123 and the second contact portion 121. The two second contact portions 121 are respectively connected to both ends of the second connecting portion 123 through two second inclined portions 125. A slope formed by the second inclined portions 125 which are arranged obliquely can make the arc longer. In particular, the slope of the second inclined portion 125 is opposite to the second arc-striking portion 115, the arc can be guided between the slope and the second arc-striking portion 115 from a contact region between the moving contact and the static contact, thereby making the arc longer and improving the utilization efficiency of the arc-extinguishing chamber 14 c and an arc-extinguishing effect. There is a drop between the second connecting portion 123 and the second contact portion 121. In a moving direction of the contact 120, a distance between the second contact portion 121 and the first contact portion 111 is smaller than a distance between the second connecting portion 123 and the first contact portion 111, and the slope of the second inclined portion 125 and the second arc-striking portion 115 are inclined to extend in the directions away from each other. The second inclined portion 125 and the second arc-striking portion 115 can be cooperatively provided with contact mechanisms of permanent magnets, and guide arcs in conjunction with the magnetic fields of the permanent magnets, thereby improving the arc-extinguishing performance. Of course, as other embodiments, the second inclined portion 125 and/or the second arc-striking portion 115 may also not be arranged.

Preferably, a first arc guide member 13 is arranged on a side of the contact 120 away from the back side of the first contact portion 111 of the static contact 11. The first arc guide member 13 includes two arc guide portions and a third connecting portion 132 connected between the two arc guide portions. The two arc guide portions extend to a direction of the arc-extinguishing chamber 14 respectively, and the arc guide portions extend to the upper side of the arc-extinguishing chamber 14, so that the arc-extinguishing chamber 14 is arranged between the first arc-striking portion 114 and the arc guide portion, thereby making the arc longer and increasing a utilization rate of the arc-extinguishing chamber 14. The two arc guide portions are a first arc guide portion 131 and a second arc guide portion 133, which are respectively used for cooperating with the first arc-striking portions 114 of the two static contacts 11. The third connecting portion 132 electrically connects the first arc guide portion 131 with the second arc guide portion 133. The contact 120 and the third arc-striking portion 122 are located between the first arc guide member 13 and the first arc-striking portion 114. The third arc-striking portion 122 extends in a direction close to the corresponding arc-extinguishing chamber 14 and the first arc guide member 13.

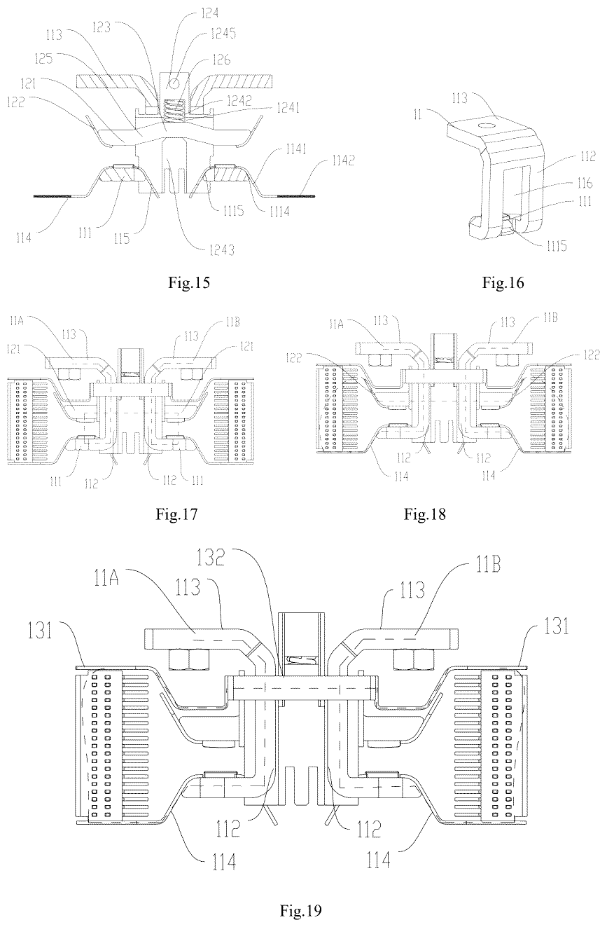

As shown in FIGS. 17-18, when the switching device in the present embodiment is opened, an arc current at an initial stage of isolation of the moving contact 12 from the static contact 11 is transferred from the static contact 11 and the moving contact 12 in FIG. 17 to the first arc-striking portion 114 and the third arc-striking portion 122 as shown in FIG. 18 and enters the arc-extinguishing chamber. As shown in FIG. 18, a current loop path at the initial stage of opening is as follows: the first wiring portion 113 of the first static contact 11A—the first connecting portion 112 of the first static contact 11A—the first arc-striking portion 114 of the first static contact 11A—the third arc-striking portion 122—the contact 120—the other third arc-striking portion 122—the first arc-striking portion 114 of the second static contact 11B—the first connecting portion 112 of the second static contact 11B—the first wiring portion 113 of the second static contact 11B.

As shown in FIG. 19, when the arc is transferred from the first arc-striking portion 114 to the first arc guide member 13, a current loop path will be transferred to: the first wiring portion 113 of the first static contact 11A—the first connecting portion 112 of the first static contact 11A—the first arc-striking portion 114 of the first static contact 11A—the first arc-striking portion 131—the third connecting portion 132 of the first arc guide member 13—the second arc guide portion 133—the first arc-striking portion 114 of the second static contact 11B—the first connecting portion 112 of the second static contact 11B—the first wiring portion 113 of the second static contact 11B, such that the utilization rate of the arc-extinguishing chamber is higher. Preferably, the third connecting portion 132 of the first arc guide member 13 is located between the first contact portion 111 of the static contact 11 and the first wiring portion 113, which is conducive to improving the arc-striking and magnetic blowing efficiency. That is, in a height direction shown in FIG. 19, the third connecting portion 132 is located between the first contact portion 111 and the first wiring portion 113, and is located between the second contact portion 121 and the first wiring portion 113. In a width direction of the switching device, the third connecting portion 132 is laminated above or below the first connecting portion 112 of the static contact 11 and the contact support 124.

The arc running structure of the contact unit 1 in the present embodiment includes a first arc-striking portion 114, a second arc-striking portion 115, a third arc-striking portion 122, a second inclined portion 125 and a first arc guide portion 13, and can quickly guide arcs to the arc-extinguishing chamber. The arc guide portions of the first arc-striking portion 114 and the first arc guide member 13 can make the arcs longer, so that the arc-extinguishing chamber 14 has higher utilization rate and can be used for a switch of higher rated current. The third arc-striking portion 122 can guide the arcs to jump faster to the first arc guide member 13. It should be noted that, as other inferior embodiments, the second inclined portion 125 or the second arc-striking portion 115 may also not be arranged, or the third arc-striking portion 122 or the first arc guide member 13 may not be arranged. Obviously, the arc running structure of the present invention may not only be used for the switching device in the present embodiment, but also used for other switching devices.

Preferably, as shown in FIGS. 14-15, a preferred specific structure of an arc running structure is shown. A first arc-shaped surface 1114 is arranged at one end of the first contact portion 111 away from the first avoidance hole 116, and a second arc-shaped surface 1115 is arranged at one end close to the first avoidance hole 116. The first arc-striking portion 114 bends and extends obliquely along the first arc-shaped surface 1114 in a direction away from the second contact portion 121. The second arc-striking portion 115 passes through the first connecting portion 112 along the second arc-shaped surface 1115 and extends obliquely in a direction opposite to the first arc-striking portion 114 and away from the second inclined portion 125. The first arc-striking portion 114 includes a first inclined section 1141 and a first straight section 1142. One end of the first arc-striking portion 114 is connected to the first contact portion 111, and bends and extends along the first arc-shaped surface 1114 to a direction away from the second contact portion 121, and the other end of the first arc-striking portion 114 is connected to the first straight section 1142. The first straight section 1142 corresponds to the arc-extinguishing chamber 14. The first straight section 1142 extends to the lower side of the arc-extinguishing chamber 14. A third arc-shaped surface is arranged at an end of the second contact portion 121. The third arc-striking portion 122 bends and extends obliquely along the third arc-shaped surface in a direction away from the first contact portion 111. A third arc-shaped surface is arranged at an end of the second contact portion 121. The third arc-striking portion 122 bends and extends obliquely along the third arc-shaped surface in a direction away from the first contact portion 111. Preferably, the thickness of the first arc-striking portion 114 and the thickness of the second arc-striking portion 115 are each less than the thickness of the static contact 11. The first arc-striking portion 114 and the second arc-striking portion 115 are welded on the static contact 11. The thickness of the third arc-striking portion 122 is less than the thickness of the contact 120. The third arc-striking portion 122 is welded on the second contact portion 121 and close to the moving contact point. The first arc-striking portion 114, the second arc-striking portion 115 and the third arc-striking portion 122 are thinner, and have arc extension and a good arc-striking effect.

Preferably, each arc guide portion of the first arc guide member 13 includes a second straight section 1301, a second inclined section 1302 and a third straight section 1303 which are connected in sequence. The third straight section 1303 and the second contact portion 121 are arranged in parallel to correspond to each other. The second inclined section 1302 and the third arc-striking portion 122 are arranged in parallel to correspond to each other. The second straight section 1301 corresponds to the arc-extinguishing chamber 14. The second straight section 1301 extends to the upper side of the arc-extinguishing chamber 14, such that the second inclined section 1302 and the third straight section 1303 are closer to the contact 120, which is conducive to fast jump of the arcs to the first arc guide member 13. The arc guide portion (131, 132) of the first arc guide member 13 and the third arc guide portion 122 in the present embodiment have overlapping portions which are parallel to each other, that is, the second inclined section 1302 of the arc guide portion and the third arc guide portion 122. Within a movement range of the moving contact, there are always overlapping portions parallel to each other, so that a shortest distance between the arc guide portion of the first arc guide member 13 and the third arc-striking portion 122 is unchanged, so that the arc can be guided to the top of the arc-extinguishing chamber through the third arc-striking portion 122 and the arc guide portion of the first arc guide member 13 quickly, thereby improving the arc-striking efficiency.

Preferably, as shown in FIGS. 14-15, a preferred specific structure of the moving contact 12 is shown. The contact support 124 is provided with a contact mounting groove 1241 for mounting the contact 120 and a spring mounting groove 1242 for mounting the contact spring 126. The contact mounting groove 1241 is communicated with the spring mounting groove 1242. The contact 120 penetrates through the contact mounting groove 1241. The second connecting portion 123 is arranged in the contact mounting groove 1241. The contact 120 is perpendicular to a moving direction of the contact support 124. The contact spring 126 is mounted in the spring mounting groove 1242. The contact spring 126 acts between the middle part of the contact 120 and the contact support 124. One end of the contact spring 126 acts on the second connecting portion 123 of the contact 120, and one end of the contact spring 126 acts on a top side wall of the spring mounting groove 1242.

Preferably, as shown in FIG. 15, the contact support 124 is provided with an arc isolation structure, which is used for isolating two breakpoint arcs on both sides of the contact support 124, which effectively avoids a mutual interference of the two breakpoint arcs, and is conducive to the arc movement to the arc-extinguishing chamber. The arc isolation structure includes a baffle plate 1243 for isolation between the first contact portions 111 of the two static contacts 11. In the present embodiment, the top end of the baffle plate 1243 extends into the contact mounting groove 1241 to support the contact 120. The baffle plate 1243 and the contact spring 126 act on both sides of the second connecting portion 123 respectively.

In the movement process of the contact support 124 in a straight line, regardless of being closed or opened, the baffle plate 1243 is always located between the first contact portions 111 of the two static contacts 11.

In the present embodiment, a lower half of the contact support 124 is used as the baffle plate 1243, and the contact support 124 extends between the two static contacts 11. As other embodiments, the baffle plate 1243 includes a protruding portion protruding out of a side surface of the contact support 124, and a plane where the protruding portion is located is perpendicular to the contact 120.

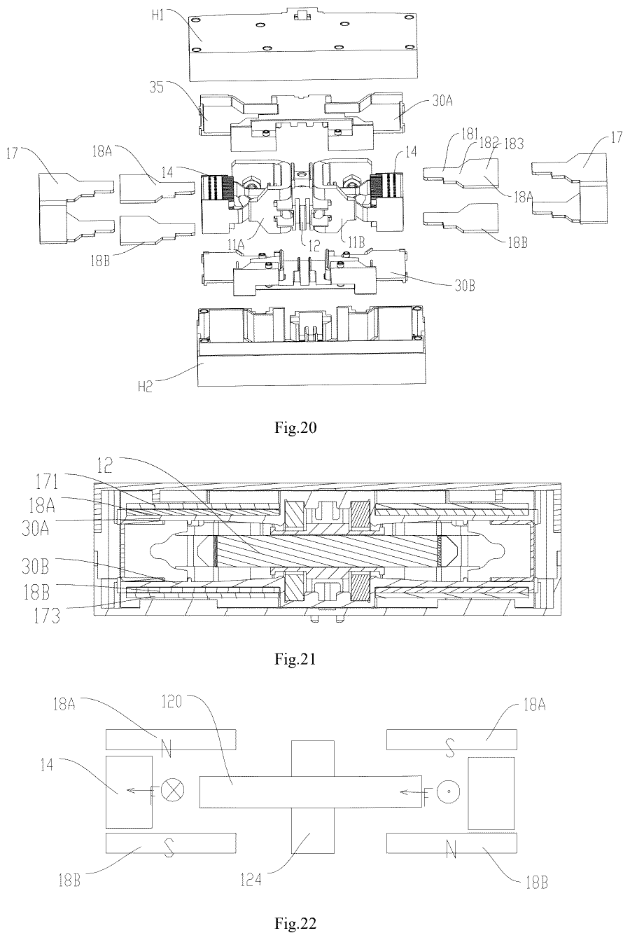

Preferably, as shown in FIGS. 20-22, the arc-extinguishing structure in the contact unit housing H of the contact unit 1 in the present embodiment includes a magnetic blowing structure. The arc is driven in a direction of the arc-extinguishing chamber 14 by utilizing a magnetic field, and is accelerated to enter the arc-extinguishing chamber 14.

The magnetic blowing structure of the contact unit 1 in the present embodiment includes two sets of permanent magnets 18 and two sets of magnetic conductive plates 17. The two sets of permanent magnets 18 correspond to two static contacts 11 and two arc-extinguishing chambers 14 respectively, and the set of magnetic conductive plates 17 is arranged on the outer side of each set of permanent magnets 18. Each set of permanent magnets 18 includes a first permanent magnet 18A and a second permanent magnet 18B arranged at intervals in parallel. A region between the first permanent magnet 18A and the second permanent magnet 18B is at least provided with the arc-extinguishing chamber 14, a first contact portion 111 of the static contact 11, a second contact portion 121 of the moving contact 12, and arc running structures between the arc-extinguishing chamber 14 and the static contact 11 and the moving contact 12.

Preferably, the magnetic conductive plates 17 include a first magnetic conductive plate 171, a second magnetic conductive plate 173 and a connecting plate 172. The first magnetic conductive plate 171 and the second magnetic conductive plate 173 are arranged in parallel. The connecting plate 172 is connected to the first magnetic conductive plate 171 and the second magnetic conductive plate 173, so that the magnetic conductive plate 17 is U-shaped. The first magnetic conductive plate 171 and the second magnetic conductive plate 173 are correspondingly arranged on the outer side of the first permanent magnet 18A and the outer side of the second permanent magnet 18B, respectively. The connecting plate 172 is correspondingly arranged on the lower side of the arc-extinguishing chamber 14 to avoid an exhaust end of the arc-extinguishing chamber 14. The connecting plate 172 is connected to lower side edges of the first magnetic conductive plate 171 and the second magnetic conductive plate 173 close to the static contact 11 and is located on the outer side of the first arc-striking portion 114.

Preferably, as shown in FIG. 22, the first permanent magnet 18A and the second permanent magnet 18B in each set of permanent magnets 18 are opposite in polarity, the first permanent magnets 18A in the two sets of permanent magnets 18 are opposite in polarity, and the second permanent magnets 18B in the two sets of permanent magnets 18 are opposite in polarity. That is, the two first permanent magnets 18A in the two sets of permanent magnets 18, which are located on the same side of the moving contact 12 in a width direction of the contact unit 1, are opposite in polarity, and the two second permanent magnets 18A in the two sets of permanent magnets 18, which are located on the same side of the moving contact 12, are opposite in polarity. The permanent magnets 18 may be permanent magnets. If the first permanent magnet 18A corresponding to the left arc-extinguishing chamber 14 is N, and the second permanent magnet 18B is S, the first permanent magnet 18A corresponding to the right arc-extinguishing chamber 14 is S, and the second permanent magnet 18B is N.

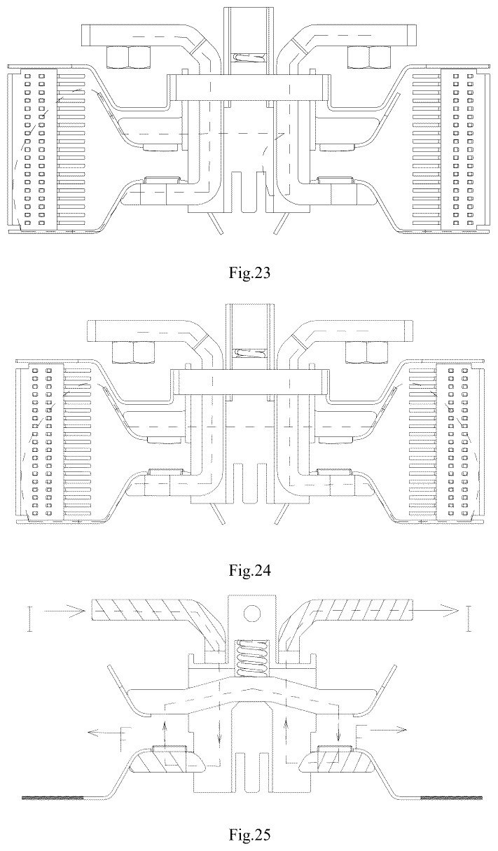

As shown in FIG. 23, when the switching device in the present embodiment is opened, in the case of small breaking current (under a normal working current), a breaking arc on the left side of the moving contact 12 moves in a direction of the arc-extinguishing chamber 14 on the left side under the action of the left set of permanent magnets 18 (along the first arc-striking portion 114 and the third arc-striking portion 122), while a breaking arc on the right side of the moving contact 12 moves in an opposite direction of the right arc-extinguishing chamber 14 under the action of the right set of permanent magnets 18 (along the second arc-striking portion 115 and the second inclined portion 125). When a current is reversed, the breaking arc on the right side of the moving contact 12 moves in a direction of the arc-extinguishing chamber 14 on the right side under the action of the right set of permanent magnets 18 (along the first arc-striking portion 114 and the third arc-extinguishing portion 122), while the breaking arc on the left side of the moving contact 12 moves in an opposite direction of the left arc-extinguishing chamber 14 under the action of the left set of permanent magnets 18 (along the second arc-extinguishing portion 115 and the second inclined portion 125), so that a polarity-free application can be realized. In the case of small current, the breaking arcs on both sides move to the respective arc-extinguishing chambers 14 by means of the corresponding permanent magnets 18. However, when the current is reversed, the breaking arcs on both sides move to the opposite direction to the respective arc-extinguishing chambers 14 by means of the corresponding permanent magnets 18, and the arcs cannot be effectively extinguished at this moment.

As shown in FIGS. 24-25, in the case of large breaking current (overload or short circuit), an excitation magnetic field of a moving and static contact conductive loop is greater than an effect of a magnetic field of the permanent magnets 18 on the arcs, an excitation magnetic field of the moving and static contact conductive loop drives a switching arc to move to the respective arc-extinguishing chambers 14. A breaking arc on the left side of the moving contact 12 moves to the left arc-extinguishing chamber 14. A breaking arc on the right side of the moving contact 12 moves to the right arc-extinguishing chamber 14.

The magnetic blowing structure of the switching device in the present embodiment can realize that when a small current (refers to a normal working current) is broken, a breaking arc on one side is driven towards the corresponding arc-extinguishing chamber, and a breaking arc on the other side is driven in an opposite direction of the corresponding arc-extinguishing chamber, thereby realizing a non-polar application. When a high current is broken, the breaking arcs on both sides move to the two arc-extinguishing chambers respectively under the excitation of the magnetic field of the conductive loop, thereby increasing an arc-extinguishing speed. Obviously, the magnetic blowing structure of the present invention may be used not only for the switching device in the present embodiment, but also for other switching devices. Moreover, the C-type structure of the static contact 11 and the structure of the first avoidance hole 116 allowing the contact 120 to pass through in this embodiment, and the arrangement of the second inclined portion 125 of the contact 120 are conducive to improving an arc-striking effect of the arc running structure and a driving force of the excitation magnetic field of the moving and static contact conductive loop of the magnetic blowing structure. It should be noted that, as other inferior embodiments, the magnetic blowing structure may also be provided with only a permanent magnet 18, but not a magnetic conductive plate 17.

In addition, the C-type structure of the static contact 11 and the structure of the first avoidance hole 116 allowing the contact 120 to pass through are also conducive to increasing an opening distance between the first contact portion 111 and the second contact portion 121 after opening. Of course, as other embodiments, the static contact 11 may also not be provided with a first avoidance hole 116. For example, the static contact 11 is integrally arranged on the upper or lower side of the contact 12, or an opening of the C-type structure of the static contact 11 is not oriented to the arc-extinguishing chamber 14, but is oriented to a direction perpendicular to a paper surface in FIG. 13, or the static contact 11 does not adopt a C-type structure, etc., all of which belong to the protection scope of the present invention.

As shown in FIG. 20, preferably, the first permanent magnet 18A and the second permanent magnet 18B are of the same structure, and each include a first permanent magnet plate 181, a second permanent magnet plate 182 and a third permanent magnet plate 183 which are connected sequentially. The third permanent magnet plate 183 corresponds to the arc-extinguishing chamber 14. The first permanent magnet plate 181 corresponds to a moving region of the second contact portion 121. The third permanent magnet plate 183 has a width greater than that of the first permanent magnet plate 181. The second permanent magnet plate 182 is connected between the first permanent magnet plate 181 and the third permanent magnet plate 183. A side edge of the second permanent magnet plate 182 is obliquely arranged and preferably corresponds at least to part of the first arc-striking portion 114 and the third arc-striking portion 122. The shape of the first magnetic conductive plate 171 and the second magnetic conductive plate 173 of the magnetic conductive plate 17 is identical with the structure of the first permanent magnet 18A and the second permanent magnet 18B.

Preferably, the switching device further includes a current detection mechanism. The current detection mechanism is used for collecting a main loop current signal of the contact unit 1. The current detection mechanism is connected to a control device. An auxiliary switch is connected in series in a power supply loop of the electromagnetic coil 21. The control device and the auxiliary switch can be connected to drive the auxiliary switch to be opened and closed. When a current has a fault, e.g., overload or short circuit, the control device controls the auxiliary switch (e.g., a relay) to cut off the power supply loop of the electromagnetic coil 21 of the electromagnetic unit 2, thereby breaking a main circuit current. In an embodiment, the current detection mechanism includes a current sensor. In the present embodiment, the current sensor is a Hall sensor. The Hall sensor is arranged on an outer side wall of the contact unit housing H. The outer side wall of the contact unit housing H is provided with a mounting groove for mounting the Hall sensor. The Hall sensor is closely attached to a conductive loop of a main loop of the static contact 11 or the moving contact 12 or the contact unit 1. The current sensor arranged on the outer side of the contact unit housing H can be well mounted as needed. Of course, as other embodiments, the current sensor may also be arranged in the contact unit housing H, or may also be used as other current sensors, such as a manganese-copper shunt. The control device includes a microcontroller MCU. The control device and the auxiliary switch for cutting off a power supply loop of the electromagnetic coil 21 may be arranged in the electromagnetic unit 2 or may also be located outside the electromagnetic unit 2, e.g., arranged in the contact unit 1, or arranged on an upper-computer device (e.g., an upper computer) of the switching device, all of which belong to the protection scope of the present invention.

Preferably, the switching device further includes a short-circuit protection mechanism. The short-circuit protection mechanism includes an electromagnetic tripping unit and an auxiliary contact. The auxiliary contact is connected in series in the power supply loop of the electromagnetic coil 21 of the electromagnetic unit 2. The auxiliary contact is a normally closed contact. In the case of short-circuit fault, the electromagnetic tripping unit acts to drive the auxiliary contact to be disconnected, the power supply loop of the electromagnetic coil 21 of the electromagnetic unit 2 is cut off. The electromagnetic unit 2 is turned off quickly in a mechanical way, and then the contact unit 1 is driven by the electromagnetic unit 2 to be quickly opened, thereby achieving fast short-circuit protection. An embodiment of an electromagnetic tripping unit includes a magnetic yoke, an armature and a spring connected between the magnetic yoke and the armature. When the magnetic yoke induces a short-circuit current, the armature moves such that the auxiliary contact is switched from normally closed to normally opened, so as to cut off the power supply of the electromagnetic coil 21. The short-circuit protection mechanism may be arranged outside the electromagnetic unit 2 and the contact unit 1 as an independent module, or may also be arranged in the contact unit 1 or the electromagnetic unit 2.

As shown in FIGS. 10 and 11, the contact unit housing H is of a cuboid structure, which includes a first upper side wall and a first lower side wall oppositely arranged at intervals, a first left side wall and a first right side wall opposite to each other, and a first front side wall and a first rear side wall opposite to each other. The first front side wall and/or the first rear side wall are/is provided with the first linkage hole 101 for the linkage rod 25 to pass through and to be connected to the contact support 124 of the moving contact 12. The first left side wall and the first right side wall of the contact unit housing H are each further provided with an exhaust port 102. The exhaust ports 102 correspond to the exhaust ends of the arc-extinguishing chambers 14 and are used for discharging an arcing gas. An air inlet end of the arc-extinguishing chamber 14 faces the static contact 11. A distance between the first upper side wall and the first lower side wall is a height of the contact unit 1, a distance between the first left wall and the first right side wall is a length of the contact unit 1, a distance between the first front side wall and the first rear side wall is a width of the contact unit 1, and a distance between the first front side wall and the first rear side wall is less than a distance between the first left wall and the first right side wall, and less than a distance between the first upper side wall and the first lower side wall.

Preferably, the first upper side wall of the contact unit 1 is provided with two power supply wiring portions 103 for connecting conductors, thereby facilitating the connection of an external power supply and a load and wiring after the switching device is assembled. Of course, as other embodiments, the power supply wiring portions 103 may also be arranged on other side walls. The two power supply wiring portions 103 are electrically connected to the two static contacts 11. Preferably, the static contacts 11 are integrally formed with the power supply wiring portions 103 of the contact unit 1. The first wiring portions 113 of the static contacts 11 extend out of the contact unit housing H as the power supply wiring portions 103 of the contact unit 1. Of course, the static contacts 11 may also be split from the power supply wiring portions 103 of the contact unit 1. A moving direction of the contact support 124 is perpendicular to the first upper side wall and the first lower side wall. An isolation protrusion 104 is arranged at a position of the first upper side wall corresponding to a moving direction of the contact support 124. The isolation protrusion 104 is located between the two power supply wiring portions 103. The isolation protrusion 104 not only increases a creepage distance between the two power supply wiring portions 103, but also forms a moving space of the contact support 124 inside the isolation protrusion 104 at the same time, so that a large opening distance between the moving contact and the static contact is ensured while the height of the contact unit 1 is reduced. The isolation protrusion 104 is arranged in correspondence to a moving trajectory of the contact support 124. The contact support 124 is capable of moving to the moving space inside the isolation protrusion 104.

As shown in FIGS. 10 and 12, the electromagnetic unit housing 20 is of a cuboid structure, which includes a second upper side wall and a second lower side wall oppositely arranged at intervals, a second left side wall and a second right side wall opposite to each other, and a second front side wall and a second rear side wall opposite to each other. The second front side wall and/or the second rear side wall are/is provided with the second linkage hole 201 for the linkage rod 25 to pass through and to be connected to the moving iron core 22. The electromagnetic unit housing 20 is provided with two control wiring portions (not shown), which are used for supplying power to the electromagnetic coil 21 and driving the moving iron core 22 to act. A distance between the second upper side wall and the second lower side wall is a height of the electromagnetic unit 2, a distance between the second left side wall and the second right side wall is a length of the electromagnetic unit 2, a distance between the second front side wall and the second rear side wall is a width of the electromagnetic unit 2, and a distance between the second front side wall and the second rear side wall is less than a distance between the second left wall and the second right side wall, and less than a distance between the second upper side wall and the second lower side wall.

Preferably, as shown in FIG. 20, the contact unit housing H includes a first base H1, a second base H2, a first module housing 30A and a second module housing 30B. The first base H1 and the second base H2 are mounted oppositely to form an outer housing of the contact unit 1. The first module housing 30A and the second module housing 30B are oppositely mounted to form an inner housing of the contact unit 1. The static contact 11, the moving contact 12 and the arc-extinguishing chamber 14 are mounted between the first module housing 30A and the second module housing 30B. A first mounting space in which the contact mechanism is arranged is formed between the first module housing 30A and the second module housing 30B, which may be connected to form an integral contact module by means of screws or pivots, buckles and the like and then integrally mounted between the first base H1 and the second base H2. The permanent magnets 18 and the magnetic conductive plates 17 are arranged between the inner housing and the outer housing. The permanent magnets 18 are arranged on the outer side of the first module housing 30A and the outer side of the second module housing 30B. The magnetic conductive plate 17 is arranged on the outer side of the permanent magnet 18. A first outer groove H341 is formed in the outer side of the first module housing 30A and the outer side of the second module housing 30B, respectively. The first permanent magnets 18A and the second permanent magnets 18B are respectively arranged in the first outer grooves H341 of the first module housing 30A and the second module housing 30B. Preferably, the first outer grooves H341 are used for mounting the magnetic conductive plates 17 at the same time. The first magnetic conductive plates 171 and the second magnetic conductive plates 173 of the magnetic conductive plates 17 are also arranged in the first outer grooves H341 of the first module housing 30A and the second module housing 30B, and the connecting plate 172 is correspondingly arranged on the lower side of the arc-extinguishing chamber 14.

It should be explained that, in the description of the present invention, the terms such as “up”, “down”, “left”, “right”, “inner” and “outer” indicating the directional or positional relations on the basis of the directional or positional relations shown in the drawings are only used for conveniently describing the present invention and simplifying the description, not indicate or imply that the referred devices or elements must have a specific orientation and be configured and operated in a specific direction; therefore, they cannot be construed as a limitation on the present invention.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. A switching device, comprising a switch housing and an electromagnetic system arranged in the switch housing, wherein the electromagnetic system comprises an electromagnetic coil, a static iron core and a moving iron core; the switch housing comprises an electromagnetic mounting cavity and at least one contact module mounting cavity which are arranged side by side; the electromagnetic system is arranged in the electromagnetic mounting cavity; a contact module is arranged in the contact module mounting cavity; the contact module comprises a contact module housing, and a static contact, a moving contact and an arc-extinguishing chamber arranged in the contact module housing; the moving iron core is connected to the moving contact through a linkage member to drive the moving contact to move in a straight line; the contact module housing is provided with a first linkage hole; and the linkage member passes through the first linkage hole to connect the moving iron core with the moving contact.

2. The switching device according to claim 1, wherein the switch housing is provided with two contact module mounting cavities inside; the two contact module mounting cavities are respectively located on both sides of the electromagnetic mounting cavity; the two contact modules are arranged in the two contact module mounting cavities; and the moving iron core of the electromagnetic system is connected to the moving contacts of the two contact modules through the linkage member.

3. The switching device according to claim 1, wherein two static contacts a moving contact and two arc-extinguishing chambers are arranged in the contact module housing; the moving contact includes a contact mounted on the contact support; the static contact is provided with a first contact portion; a second contact portion is arranged at both ends of the contact, respectively; and the contact support is capable of moving in a straight line to drive the two second contact portions of the contact to be in contact with or separated from the first contact portions of the two static contacts.

4. The switching device according to claim 3, wherein the two static contacts are arranged on both sides of the contact support; the two arc-extinguishing chambers are symmetrically arranged on both sides of the two static contacts; and the two static contacts are respectively located between the corresponding arc-extinguishing chamber and the contact support.

5. The switching device according to claim 2, wherein two sets of permanent magnets are also arranged in the switch housing; the two sets of permanent magnets are arranged to correspond to the two static contacts and the two arc-extinguishing chambers, respectively; each set of permanent magnets comprises a first permanent magnet and a second permanent magnet which are arranged at intervals in parallel; and a region between the first permanent magnet and the second permanent magnet is at least provided with the corresponding arc-extinguishing chamber, the first contact portions of the static contacts and the second contact portion of the moving contact.

6. The switching device according to claim 5, wherein two sets of magnetic conductive plates are further arranged in the switch housing; a set of magnetic conductive plates is arranged on the outer side of each set of permanent magnets; the magnetic conductive plates comprise a first magnetic conductive plate, a second magnetic conductive plate and a connecting plate; the first magnetic conductive plate and the second magnetic conductive plate are arranged in parallel; the connecting plate is connected to the first magnetic conductive plate and the second magnetic conductive plate; and the first magnetic conductive plate and the second magnetic conductive plate are correspondingly arranged on the outer side of the first permanent magnet and the outer side of the second permanent magnet respectively.

7. The switching device according to claim 5, wherein the first permanent magnet and the second permanent magnet in each set of permanent magnets are opposite in polarity.

8. The switching device according to claim 5, wherein first outer grooves for mounting the permanent magnets are formed in the outer side of the contact module housing; and the first outer grooves are used for mounting the magnetic guide plates at the same time.

9. The switching device according to claim 3, wherein the static contact is provided with a first arc-striking portion; the first arc-striking portion is connected to the first contact portion and extends to one side of the corresponding arc-extinguishing chamber in a direction of the corresponding arc-extinguishing chamber; the contact is provided with a third arc-striking portion; and the third arc-striking portion is connected to the second contact portion and extends in the direction of the corresponding arc-extinguishing chamber.

10. The switching device according to claim 9, wherein the static contact is also provided with a second arc-striking portion; and the second arc-striking portion is connected to the first contact portion and extends in a direction opposite to an extension direction of the first arc-striking portion.

11. The switching device according to claim 10, wherein the contact comprises a second connecting portion, two second contact portions and two second inclined portions; the two second contact portions are respectively connected to both ends of the second connecting portion through the two second inclined portions; a slope of the second inclined portion is opposite to the second arc-striking portion; and a slope of the second inclined portion and the second arc-striking portion are both inclined in directions away from each other.

12. The switching device according to claim 3, wherein the two static contacts are located on the same side of the moving contact; an arc isolation plate and an arc isolation plate spring are arranged in the contact module housing); the arc isolation plate is arranged between the two static contacts and is used for separating two breakpoint arcs; the arc isolation plate spring is connected to the arc isolation plate and used for driving the arc isolation plate to move toward the moving contact; and when the moving contact moves to the two static contacts and closes, the arc isolation plate can be pushed to compress the arc isolation plate spring.

13. The switching device according to claim 3, wherein the static contact is provided with a first avoidance hole; and the second contact portions at both ends of the contact pass through the first avoidance holes of the two static contacts respectively and cooperate with the first contact portions of the corresponding static contacts.

14. The switching device according to claim 13, wherein the static contact comprises a first contact portion, a first connecting portion and a first wiring portion; the first contact portion, the first connecting portion and the first wiring portion are sequentially connected into a C-type structure; the first contact portion and the first wiring portion are oppositely arranged at intervals; both ends of the first connecting portion are respectively connected to one end of the first contact portion and one end of the first wiring portion; openings of the C-type structures of the two static contacts are arranged away from each other, and are oriented to the corresponding arc-extinguishing chambers; the first connecting portion is provided with a first avoidance hole; and the second contact portions at both ends of the contact pass through the first avoidance holes of the two static contacts respectively and cooperate with the first contact portions corresponding to the static contacts.

15. The switching device according to claim 9, wherein a first arc guide member is arranged on one side of the contact away from the first contact portion of the static contact; the first arc guide member comprises two arc guide portions and a third connecting portion connected between the two arc guide portions; and the two arc guide portions extend to the other sides of the two arc-extinguishing chambers respectively, so that the arc-extinguishing chamber is arranged between the first arc-striking portion and the arc guide portion.
